(19) United States
(12) Patent Application Publication
(10) Pub. No.: US 2015/0274933 A1
(43) Pub. Date: Oct. 1, 2015

(54) COMPOSITION

(71) Applicant: LANXESS Deutschland GmbH, Cologne (DE)

(72) Inventor: Thomas FACKLAM, Leverkusen (DE)

(21) Appl. No.: 14/666,577

(22) Filed: Mar. 24, 2015

(30) Foreign Application Priority Data
Mar. 28, 2014 (EP) 14162209.2

(51) Int. Cl. C08K 5/42; C08J 3/18; C09J 127/06; C08K 5/1515; C09D 127/06

(52) U.S. Cl. CPC C08K 5/42; C08K 5/1515; C09D 127/06; C09J 127/06; C08J 3/18; C08J 2327/06

(57) ABSTRACT

Compositions based on aryl alkylsulphonates and epoxidized vegetable oils provide suitable plasticizers for plastics, in particular for polyvinyl chloride, and for the production of plastisols.

The present invention relates to novel compositions based on aryl alkylsulphonates and on epoxidized vegetable oils and use thereof as plasticizers for plastics.

### BACKGROUND INFORMATION

Plasticizers have been in use for decades for the processing of plastics such as polyvinyl chloride

(PVC). Plasticizers are additive& which are used in polymer processing and which improve processability, flexibility and extensibility. Because there is no irreversible bonding between the plasticizers and the polymer, they can migrate or evaporate. Most of the plasticizers that are currently in frequent use for the production of flexible PVC are phthalic esters such as di-2-ethylhexy/phthalate (DEHP), diisononyl phthalate (DLNP) and diisodecyl phthalate (DIDP).

However, the use of phthalates is subject to constant further restriction imposed by legislation. One example is the banning of, and the restriction of use of, some phthalates in the production of toys and baby products (Directive 2005/84/EG of the European Parliament and of the Council of 14 Dec. 2005), The European Chemicals Agency (ECHA) has also included a number of phthalates in the list of candidates for substances of very high concern (SVHC), There is therefore a requirement for phthalate-free plasticizers for plastics.

Compounds from the class of the aryl alkylsulphoriates provide a proven alternative to the phthalate-based plasticizers. MESAMOLL® from LANXESS Deutschland GmbH is a member of this class. Significant properties of MESAMOLL® as plasticizer for PVC are excellent gelling capability and very good plasticizing action.

It has moreover been known for a long time that epoxidized vegetable oils, for example epoxidized soya bean oil (ESBO) and epoxidized linseed oil (EU)), can be used as plasticizers in PVC. A disadvantage with the use of epoxidized vegetable oils such as ESBO or ELO is their high viscosity and low level of plasticizing action. In addition to this, when quantities used are high incompatibility with PVC begins to be apparent, and has an adverse effect on the service life of the final products.

The intended function of a plasticizer in a plastic, in the final product produced after processing, for example in a fully gelled, plasticized polyvinyl chloride preparation is not only to provide the desired softness but also to have very good resistance to migration from the final product into adjacent plastics.

The plasticizers known from the prior art still require improvement in respect of the abovementioned disadvantages.

There therefore continues to be a requirement for a phthalate-free plasticizer for plastics with good processability, little susceptibility to migration, and long lifetime of the resultant final products.

The object of the present invention was to provide novel phthalate-free plasticizers for plastics which have good performance characteristics and little susceptibility to migration into adjacent plastics.

### SUMMARY OF THE INVENTION

It has now been found that a composition comprising at least one aryl alkylsulphonate and at least one epoxidized vegetable oil has very good suitability as plasticizer for plastics.

The term “composition” means a mixture or preparation made of two or more components. All of the compositions claimed with the term “comprising” can also, unless expressly otherwise defined, comprise additives or auxiliaries and additional substances.

The invention provides compositions comprising
a) at least one aryl alkylsulphonate and
b) at least one epoxidized vegetable oil, and the ratio by weight of component a) to component b) is from 4:1 to 1:4.

### DETAILED DESCRIPTION OF THE INVENTION

In one preferred embodiment, the composition of the invention comprises components a) and b) in a ratio by weight of from 2:1 to 1:2.

In a likewise preferred embodiment, the composition of the invention comprises a quantity of from 20 to 80% by weight, preferably a quantity of from 33 to 67% by weight and very particularly preferably from 40 to 60% by weight, of component a) and a quantity of from 80 to 20% by weight, preferably a quantity of from 67 to 33% by weight and very particularly preferably from 60 to 40% by weight, of component b), where the sum of the percentages by weight of components a) and b) is always 100%.

The compositions of the invention can either consist only of components a) and b) or comprise one or more additional substances. In this case the quantities of component a) and component b) are to be selected within the stated ranges in such a way that the entirety of all of the components in the composition gives 100%.

For clarification, it should be noted that the scope of the invention encompasses any desired combination of all of the definitions and parameters mentioned in general terms or in preferred ranges.

The compositions of the invention preferably comprise, as component a), at least one aryl alkylsulphonate of the general formula (I)

R—SO₂—O—R² (I)

in which
R¹ is straight-chain or branched C₃₀- to C₂ alkyl,
   and
R² is unsubstituted phenyl or is phenyl which has one, two or three C₁ to C₄alkyl substituents.

The following may be mentioned as substituted phenyl: 2-, 4- and 6-methylphenyl, 2,6-dimethyl-phenyl, 2,4-dimethylphenyl, 2,4,6-trimethylphenyl, 2,4-dimethyl-6-tert-butylphenyl, 2-, 4- and 6-isopropylphenyl, 2-, 4- and 6-n-butylphenyl and 2-, 4- and 6-tert-butylphenyl.

The compositions of the invention particularly preferably comprise, as component a), at least one aryl alkylsulphonate of the formula (I) in which
R¹ is straight-chain C₁₀- to C₂₁-alkyl, very particularly preferably straight-chain C₁₀- to C₁₅-alkyl, in particular straight-chain C₁₄ to C₁₇-alkyl, and
R² is phenyl.

In particular, R¹ is C₁₄-, C₁₅-, C₁₆- or C₁₇-alkyl.

In one preferred embodiment, the compositions of the invention comprise, as component a), as mixture of at least two phenyl C₁₄- to C₁₇-alkylsulphonates, e.g. MESAMOLL® (commercially available product from LANXESS Deutschland GmbH, CAS numbers 91082-17-6 and 70775-'94-9), Components b) present in the compositions of the invention are epoxidized vegetable oils. Preference is given to epoxidized soya oil, epoxidized linseed oil, epoxidized olive oil, epoxidized colza epoxidized sunflower oil, epoxidized palm kernel oil, epoxidized palm oil, epoxidized coconut oil, epoxidized rapeseed oil, epoxidized castor oil and epoxidized safflower oil. The compounds mentioned can be used individually or in any desired mixture with one of them. Particular preference is given to epoxidized soya bean oil (CAS No. 8013-07-8) and/or epoxidized linseed oil (CAS No. 8016-11-3) as component b).

The epoxy oxygen content in the epoxidized vegetable oils of component b) is generally from 6 to 11 per cent by weight, based on the total weight of the vegetable oil. The epoxy oxygen content in the epoxidized soya bean oil preferably used is from 6 to 8 per cent by weight, and in the epoxidized linseed oil it is from 8.5 to 11 per cent by weight.

The epoxidized vegetable oils are known and are available commercially, examples being epoxidized soya bean oil from Varteco Quimica Puntana S.A., and epoxidized linseed oil from HallStar.

In one preferred embodiment the compositions, the polymer compositions and the plastics of the invention are in essence phthalate-free.

In essence phthalate-free means for the purposes of the invention phthalate content of less than 0.1% by weight, in particular less than 0.01% by weight, based on the weight of the entirety of components a) and b), It is very particularly preferable that the compositions, the polymer compositions and the plastics of the invention are phthalate-free. They therefore comprise no phthalates other than traces that are ubiquitous in the environment.

The phthalates class of compounds is known to the person skilled in the art. The compositions of the invention in particular comprise no members of this class of compounds. Examples that may be mentioned of these phthalates are benzyl butyl phthalate (BBP), di-2-ethylhexyl phthalate (DEHP), diisononyl phthalate (DINP) and diisodecyl phthalate (DIDP).

The compositions of the invention have excellent suitability as plasticizers for plastics.

The compositions of the invention optionally comprise at least one further auxiliary and/or additional substance. Auxiliaries and additional substances that can be used are preferably those usually used in plasticizer preparations. The quantities used of these are those usually used for these auxiliaries and additional substances. Particular auxiliaries and additional substances that can be used are liquid plasticizers, liquid diluents and/or liquid or soluble stabilizers.

In one preferred embodiment, the viscosity of the compositions of the invention at 23° C. is from 100 mPas to 400 mPas, in particular from 150 mPas to 300 mPas, measured with a rotary viscometer using an MS-Z3 DIN measurement system.

The present invention further provides the use of the compositions of the invention as plasticizers for plastics, in particular for thermoplastics and rubber.

For the purposes of the present invention, the term “plastics” means macromolecular, polymeric compounds which have been produced via reaction of monomeric compounds, e.g. by a polymerization reaction; it comprises homopolymers and equally copolymers.

For the purposes of the present invention the term “thermoplastics” means polymers which above a certain temperature become soft and can be shaped, and are therefore flowable at high temperatures below the decomposition temperature, and resolidify on cooling. A polymer is a macromolecular compound produced via reaction (e.g., polymerization, polycondensation) of monomers of identical or different type. Thermoplastics are produced by chain polymerization, polyaddition and/or polycondensation,

The term “rubber” covers natural and synthetic rubber. For the purposes of the present invention, the term “rubber” means elastomer; at temperatures up to their decomposition temperature these are crosslinked (vulcanized) polymer materials; at low temperatures they are glassy and hard, and even at high temperatures they do not undergo viscous flow but instead exhibit elastomeric properties, in particular at room temperature. Elastomeric behaviour is characterized by a relatively low shear modulus with comparatively small temperature-dependency,

The compositions of the invention are preferably suitable as plasticizers for plastics from the group of polyvinyl chloride, vinyl-chloride-based copolymers, polyvinylidene chloride, polyvinyl acetals, polyacrylates, polyamides, polyurethanes, polylactides, polylactic acids, cellulose and its derivatives, rubber polymers (rubber) such as acrylonitrile-butadiene rubber, hydrogenated acrylonitrile-butadiene rubber, chloroprene rubber, chlorinated polyethylene, chlorosulphonyl polyethylene, ethylene-propylene rubber, acrylate rubber and/or epichlorohydrin rubber. The plastics mentioned can also be present in any desired mixture with one another. Particular preference is given to polyvinyl chloride.

Types of PVC that can be used are by way of example suspension, bulk, microsuspension PVC, and preferably emulsion PVC,

In one preferred embodiment, the PVC solubility temperature of the composition of the invention is from 119° C. to 150° C., in particular from 130° C. to 140° C. Suitable types of PVC are set out in the experimental section of the present description.

The solubility temperature is the temperature at which a heterogeneous mixture of plasticizer and PVC becomes a homogeneous mixture, i.e. the temperature at which a particular PVC gives a clear solution in plasticizers. The PVC solubility temperature of plasticizers is closely related to the ability of a plasticizer to gel PVC. It is a measure of possible processing speed and of the PVC compatibility of a plasticizer. A low solubility temperature (<140° C.) indicates a possibility of rapid processing and of good compatibility; a high solubility temperature (>160° C.) indicates moderate processability; a very high solubility temperature (>190° C.) or the absence of any determinable solubility temperature (>200° C.) indicates that the potential plasticizer has poor PVC compatibility or is incompatible. A method for determining the solubility temperature is set out in the experimental section of the present description.

The quantity of the compositions of the invention used in use thereof as plasticizers for plastics are preferably from 1 to 300 parts for every 100 parts of plastic, with preference from 10 to 150 parts for every 100 parts of plastic, with particular preference from 20 to 100 parts for every 100 parts of plastic.

The quantity of the compositions of the invention used in use thereof as plasticizers for PVC are preferably from 20 to 300 parts for every 100 parts of PVC, with preference from 40 to 150 parts for every 100 pans of PVC, with particular preference from 50 to 100 parts for every 100 parts of PVC.

The present invention also provides polymer compositions comprising at least one Composition of the invention, at least one plastic c) and optionally at least one polymer additive i).

For the purposes of the present invention it is possible to use, as polymer additives 1), by way of example compounds from the group of the plasticizers, light stabilizers, biostabilizers and other stabilizers, antioxidants, lubricants, fillers, pigments, flame retardants, blowing agents, kickers, polymeric processing aids, impact modifiers, diluents, optical brighteners and antistatic agents.

In one preferred embodiment of the present invention the polymer compositions of the invention involve a polyvinyl chloride preparation.

It is preferable that the polyvinyl chloride compositions of the invention comprise, for every 100 parts by weight of at least one polyvinyl chloride, from 20 to 300 parts by weight, preferably from 40 to 150 parts by weight, particularly preferably from 50 to 100 parts by weight, of at least one composition of the invention and from 0 to 90 parts by weight, preferably from 5 to 70 parts by weight and particularly preferably from 10 to 60 parts by weight, of at least one polymer additive i).

When the compositions of the invention are used as plasticizers they have good performance characteristics, and in particular they can provide an appropriate processing speed, they provide high thermal stability to the final product, and a feature of the compositions is that they have little susceptibility to migration into adjacent plastics,

In particular when the compositions of the invention are used for the production of plasticized PVC, a surprising finding is that contact with other plastics such as polystyrene (PS) or acrylonitrile-butadiene-styrene copolymer (ABS) results in less migration from the resultant plasticized PVC into these plastics than would be expected from a linear relationship of the migration of the individual components of the composition of the invention,

The use of the compositions of the invention in plasticized plastics permits production of long-life products, because their susceptibility to migration into adjacent plastics has been minimized.

The compositions and polymer compositions of the invention can be produced in a known manner via mixing of components a) and b) and optionally at least one polyvinyl chloride r) and optionally at least one polymer additive i) in a mixing apparatus, preferably in agitator units and mixing units, dilution systems and static mixers, in the quantitative proportions stated for these components, It is possible here to begin by mixing components a) and b) of the composition of the invention and then to mix these with components c) and optionally i), or to add each of components a) and b) separately to components c) and optionally i) and then to mix the mixture,

The form in which the polyvinyl chloride compositions of the invention are mixed can be that of dry mixture, of dry blends, or of liquid mixtures, or of pastes, and these can optionally be further processed after an additional treatment to give the granulated material.

A non-restrictive list of processing methods of this type is: extrusion, injection moulding, spraying, calendering, rotomoulding, dip-coating, or other coating processes, spreading, sintering and casting.

The present invention also provides a process for the production of plasticized plastic, in particular plasticized polyvinyl chloride, which is characterized in that at least one plastic, in particular polyvinyl chloride, is mixed and homogenized with a composition of the invention in a mixing device, then the mixture is shaped, in particular via extrusion, injection moulding, spraying, calendering, rotomoulding, dip-coating, or other coating processes, spreading, sintering or casting, and the shaped mixture is then heated, preferably to a temperature in the range from 150 to 220° C.

The present invention likewise provides the plastics, in particular polyvinyl chloride, produced by means of the compositions of the invention.

The plastics of the invention can be further processed. Particular final products here are floors, wallpapers, synthetic leather, profiles, wire sheathing and cable sheathing, films, coatings and coating compositions, lacquers, paints, inks, adhesives, sealants, components of adhesives, components of sealants and components of adhesive sealants.

The present invention therefore also provides the use of the polymer preparations of the invention and of the compositions of the invention for the production of the final products mentioned.

The examples below illustrate the preparations of the invention without restricting the scope of the invention.

### EXAMPLES

### A) Determination of Solubility Temperature

48.0 g of the substance to be tested were weighed into a glass beaker with magnetic stirrer bar and thermometer. The glass beaker was placed in a holder on a heatable magnetic stirrer between a lamp and a photocell, The photocell recorded the change in light transmittance of the sample, 2 g of polyvinyl chloride (Vinnolit®S4170; Vinnolit GmbH & Co. KG, Germany*) were then added, and a pipette was used to add 2 drops of PVC stabilizer (orgariotin stabilizer, Mark® CZ 11). The polyvinyl chloride was stirred into the plasticizer, and the mixture was heated rapidly at from 5 to 8″C per minute to 100° C., with stirring, and then further heated at an average of 3° C. per minute. The solubility temperature was considered to have been reached when for 3 successive minutes no further rise in the transmittance value was recorded by the photocell, and the polyvinyl chloride had been dissolved. Measurement was terminated when the temperature of the contents of the glass beaker reached 200T. A low solubility temperature indicates that the plasticizer has good polyvinyl chloride compatibility.

The product Vinnolit® S4170 from Vinnolit GmbH & Co, KG, Germany is a suspension PVC with 1.5 K value (in accordance with ISO 1628-2) about 70, reduced viscosity (in accordance with ISO 1628-2) about 124 and bulk density (in accordance with ISO 60) about 0.480.

The method described above was used to determine the solubility temperature for the individual components of Examples In and 5a set out in Table 1 and for the compositions of the invention of Examples 2a to 4a.

TABLE 1

| Example | 1a | 2a | 3a | 4a | 5a |
|---|---|---|---|---|---|
| Mesamoll ®¹⁾ | 0% | 33% | 50% | 67% | 100% |
| ESBO²⁾ | 100% | 67% | 50% | 33% | 0% |
| Solubility temperature [° C.] | 150 | 140 | 134 | 130 | 119 |

¹⁾Product from Lanxess Deutschland GmbH, Germany, CAS number 91082-17-6
²⁾Product from Varteco Quitnica Puntana S.A., Argentina, CAS number 8013-07-8.

As can be seen from the results in Table 1, a feature of the compositions of the invention in comparison with the individual component ESBO is a lower solubility temperature and therefore good polyvinyl chloride compatibility.

### Determination of plasticizer Migration

A rod was used to mix 100 g of polyvinyl chloride (Vinnolit® S4170, Vinnolit GmbH & Co. KG, Germany) with 60 phr (parts by weight per 100 parts by weight of PVC) of plasticizer or plasticizer preparation and 3 phr of PVC stabilizer (Ca/Zn carboxylate) in a porcelain dish in such a way that the liquid constituents were successfully absorbed by the powder, rather than adhering to the vessel. The resultant powder mixture was charged in portions to the nip (0.7 mm) of a two-roll mill at 165° C. roll temperature, and homogenized and gelled. Once the milled sheet had formed, the nip was widened to 1 mm. The success of the mixing process was improved by frequent turning of the milled sheet. After 10 minutes of mixing time and processing time, the milled sheet was removed. After portioning, test films were pressed (thickness 1.2 mm). The press temperature was 170° C.; total press time was 10 minutes, including 7 minutes of heating phase with pressure<10 bar and 3 minutes of press time under high pressure>100 bar. After cooling under pressure in a cooling press to at most 30° C., the test samples were demoulded, and discs (diameter 5 cm) were punched out from the material. The test films and contact films were weighed precisely to 0.0001 g. A test film was then placed between two contact films (6 cm disc, thickness 1 mm). These sandwiches were placed between two glass plates. The resultant test arrangement was loaded with a 5 kg weight and placed for 12 days in the drying oven at 70° C. After 12 days the samples were removed; after cooling for at least 1 h the test films and contact films were weighed. The test comprised 3 determinations. The weight loss of the test film and the weight increase of the contact films were determined. The results were evaluated as percentages. When plasticizer mixtures were used, the weight loss of the test films (calculations in weight loss column in Table 2) was calculated by calculating the weight losses of each of the individual substances from the test films and adding these.

Measurements were made with contact films made of polystyrene (PS) and acrylonitrile-butaliene-styrene copolymer (ABS). Tables 2 and 3 list the results. A small weight change means less migration, longer retention time of the plasticizer in the plasticized plastic, and higher resistance to migration.

Migration from test samples with in each case 60 phr content of plasticizer or plasticizer mixture was determined for the plasticizer mixtures of the invention of Examples 2b to 4b and Examples 1b and 5b not of the invention. A low percentage for weight loss from the test film and for plasticizer absorption by the contact films indicates good migration resistance of the plasticizer.

TABLE 2
Migration from plasticized PVC in
contact with PS after storage for 12 days

| Ex- | | Experimental | Calculated weight |
|---|---|---|---|
| amples | Plasticizer | weight loss | loss |
| 1b | Mesamoll ® (60 phr) | 5.24% | — |
| 2b | Mesamoll ® (40 phr) + | 1.61% | 3.50% |
| | ESBO (20 phr) | | |
| 3b | Mesamoll ® (30 phr) + | 0.85% | 2.64% |
| | ESBO (30 phr) | | |
| 4b | Mesamoll ® (20 phr) + | 0.36% | 1.77% |
| | ESBO (40 phr) | | |
| 5b | ESBO ® (60 phr) | 0.04% | — |

TABLE 3
Migration from plasticized PVC in contact
with ABS after storage for 12 days

| Ex- | | Experimental | Calculated weight |
|---|---|---|---|
| amples | Plasticizer | weight loss | loss |
| 1b | Mesamoll ® (60 phr) | 2.88% | — |
| 2b | Mesamoll ® (40 phr) + | 0.31% | 1.94% |
| | ESBO (20 phr) | | |
| 3b | Mesamoll ® (30 phr) + | 0.08% | 1.47% |
| | ESBO (30 phr) | | |
| 4b | Mesamoll ® (20 phr) + | 0.07% | 1.00% |
| | ESBO (40 phr) | | |
| 5b | ESBO (60 phr) | 0.06% | — |

### Evaluation

Table 1 shows that the solubility temperature of the compositions of the invention is in the required range below 180° C. The preparations of the invention can therefore be used as efficient plasticizers.

Tables 2 and 3 show that the. extent to which the compositions of the invention migrate from PVC plasticized therewith into contact polymers is distinctly less than would be expected from calculation based on the migration data for the individual components. When the plasticizer compositions of the invention are in contact with other plastics such as PS and ABS they remain within the plasticized PVC. Surprisingly, the use of the compositions of the invention therefore permits production of final products with longer life.

What claimed is

1. A composition comprising:
a) at least one aryl alkylsulphonate; and
b) at least one epoxidized vegetable oil;
wherein a ratio by weight of component a) to component b) is 4:1 to 1:4.

2. The composition according to claim 1, wherein the ratio of component a) to component b) is 2:1 to 1:2.

3. The composition according to claim 1, wherein component a) comprises at least one aryl alkylsulphonate of the general formula (I)
R¹—SO₂—O-R² (I)
in which
R¹ is straight-chain or C₁₀- to C₂₁-alkyl, and
R² is unsubstituted phenyl or is phenyl which has one, two or three C₁- to C₄-alkyl substituents.

4. The composition according to claim 1, wherein component b) comprises at /east one epoxidized vegetable oil selected from the group of epoxidized soya oil, epoxidized linseed oil, epoxidized olive oil, epoxidized colza oil, epoxidized sunflower oil, epoxidized palm kernel oil, epoxidized palm oil, epoxidized coconut oil, epoxidized rapeseed oil, epoxidized castor oil, and epoxidized safflower oil.

5. The composition according to claim 1, wherein component b) comprises epoxidized soya bean oil and/or epoxidized linseed oil,

6. The composition according to claim 1 having a PVC solubility temperature of 119° C. to 150° C.

7. The composition according to claim 1, wherein the composition is free from phthalates.

8. A method for producing polymers such as thermoplastics and rubber with the composition according to claim 1, the method comprising including the composition according to claim I in the polymer as a plasticizer for the polymer.

9. The method according to claim 8, wherein the polymers include at least one polyvinyl chloride,

10. A polymer composition comprising:
a composition according to claim 1;
at least one polymer; and
optionally at least one polymer additive.

11. The polymer composition according to claim 10, wherein the polymer comprises at least one polyvinyl chloride.

12. A process for the production of a composition according to Claim I or of a polymer composition according to claim 10, the process comprising mixing components a) and b), optionally at least one polymer, and optionally at least one polymer additive, in a mixing apparatus with the ratio by weight of component a) to component b) of 4:1 to 1:4.

13. A process for the production of plasticized plastic, the process comprising:
mixing and homogenizing at least one plastic with a composition according to Claim I and optionally at least one polymer additive in a mixing device,
shaping the mixture; and
heating the shaped mixture to a temperature of 150° C. to 220° C.

14. A plastic comprising a composition according to claim 1,

15. A method for the production of mouldings such as floors, wallpapers, synthetic leather, profiles, wire sheathing, cable sheathing, films, coatings, coating compositions, lacquers, paints, inks, adhesives, sealants, components of adhesives, components of sealants, and components of adhesive sealants from at least one plastic according to claim 14, the method comprising forming the at least one plastic into a shaped moulding to produce a corresponding moulding,

16. Floors, wallpapers, synthetic leather, profiles, wire sheathing and cable sheathing, films, coatings and coating compositions, lacquers, paints, inks, adhesives, sealants, components of adhesives, components of sealants and components of adhesive sealants comprising a plastic according to claim 14 or a polymer composition according to claim 10,

17. The composition according to claim I, wherein:
component a) comprises at least one aryl alkylsulphonate of the general formula (I)
R¹—SO₂—O—R² (I)
in which
R¹ is straight-chain or branched C₁₀- to C₂₁-alkyl, and
R² is unsubstituted phenyl or is phenyl which has one, two or three C₁- to C₄-alkyl substituents; and
component b) comprises at least one epoxidized vegetable oil selected from a group that includes epoxidized soya oil, epoxidized linseed oil, epoxidized olive oil, epoxidized colza oil, epoxidized sunflower oil, epoxidized palm kernel oil, epoxidized palm oil, epoxidized coconut oil, epoxidized rapeseed oil, epoxidized castor oil, and epoxidized safflower oil.

18. The composition according to claim 17, wherein:
the ratio of component a) to component b) is 2:1 to 1:2; and
component b) comprises epoxidized soya bean oil and/or epoxidized linseed oil.
